(19) United States
(12) Patent Application Publication
(10) Pub. No.: US 2006/0036675 A1
(43) Pub. Date: Feb. 16, 2006

(54) Method and system for energy management and optimization.

(76) Inventor: Henry B. Crichlow, Norman, OK (US)

Correspondence Address: HENRY CRICHLOW, 330 W. GRAY ST., SUITE 504, NORMAN, OK, 73069, US

(21) Appl. No.: 10/907,925

(22) Filed: Apr. 21, 2005

Related U.S. Application Data
(60) Provisional application No. 60/564,738, filed on Apr. 26, 2004.

(51) Int. Cl. G06F 15/16

(52) U.S. Cl. 709/203

(57) ABSTRACT

A method and a system for utilizing expensive energy management software systems via the internet by a plurality of remote client users without having the major software systems resident on the internet, but resident offline, on a separate primary desktop computer. The remote client user utilizes an intermediary website. The primary desktop uses a set of software agents to crawl the Internet to locate the client energy data. The primary desktop launches the software agents to upload and update the client websites. A status flag tells the client when the data transaction is complete. The primary user can purchase a simple single-user license which resides on his desktop in a single CPU or as the industry says on a single “seat” and provide energy management to a plurality of users.

### CROSS REFERENCE TO RELATED APPLICATIONS

This application claims priority from provisional application No. 60/564,738 filed Apr. 26, 2004 and Disclosure Document 547,088 filed Feb. 17, 2004 by Dr. Henry Crichlow. This application is related to application Ser. No. 10/016,049 filed Dec. 12, 2001, application Ser. No. 10/033,667, filed Dec. 27, 2001 and application Ser. No. 60/564,738 filed Apr. 26, 2004 filed by the inventor.

### INTRODUCTION

This invention relates generally to a new technology application in energy management, which allows a primary computer user to use the internet to upgrade and utilize data and information derived from a plurality of other remote sources without having to utilize internet-resident, expensive, dedicated, complicated or complex applications modules or programs for data manipulation which must reside on the internet or internet servers. Specific embodiments of this invention described herein relate to optimization of energy and energy management in the utility industry.

1. Field of Invention

THIS INVENTION is a unique new approach to allow customer energy use data from a plurality of users to be managed via the internet without the need for expensive duplications of expensively licensed program modules on each server or the necessity of the program modules to be even resident on the internet. The optimization application modules can be resident on a desktop computer used by a primary user that is connected to the Internet by dialup or other communication means.

With this invention, the primary user can provide application related services to its customers without the primary application module being resident on the Internet. This obviates the need for the primary user to incur the expense of a large Internet based program and its attendant costly license fees, maintenance fees or other deployment fees which are usually needed to administer a set of applications software on a networked system. The primary user can purchase a simple single-user license which resides on his desktop in a single CPU or as the industry says on a single “seat”. The information is then provided to the primary user from a plurality of users in a manner dependent on mobile software agents as described in this invention.

2. Prior Art

The prior art is divided into two major areas. First, energy management and second, use of software agents. Energy management is a major sub-industry within the overall energy industry complex, in which companies and third parties monitor, record and optimize the use of electricity, gas and other energy producing commodities for commercial and industrial and residential customers. In the current technology there have been many patents and publications dealing with the hardware and the software elements involved; a representative sample of which are shown later. Use of software agents today has become a pervasive activity and these software constructs have become a staple of life on the internet from “shop bots” used in shopping to agents updating financial transactions online.

Most of the energy management work has focused on hardware use, integrating sensors and control system to lower energy use in a complex of facilities or buildings or on a distributed network of end users like a set of factories.

U.S. Pat. No. 6,868,682 teaches a method for controlling the temperature in a data center based on monitoring temperature data, processing the sensory data to determine if the subsystems in the data center are operating within a predetermined temperature range and adjusting a delivery rate for a cooling fluid to keep the temperature range of the subsystem within the predetermined temperature range.

U.S. Pat. No. 6,813,525 teaches a programmable hardware control system which includes a control module having one or more inputs to an external sensor device. An external actuator device capable of manual override and providing a status feedback signal is connected to the control system.

U.S. Pat. No. 6,785,592 proposes a business methodology for optimizing building energy use and procurement of energy. After ascertaining a baseline model, energy consumption is monitored by remote access and adjusted to reflect dynamic economic factors of operations. Over time, an energy use model is developed which can be used to modify usage and operations patterns.

U.S. Pat. No. 6,757,591 provides for a closed loop system in which an energy management method is provided for managing the generation and distribution of energy from an energy source to a building. Excess energy is stored and an energy optimizing controller is used to maximize operations.

U.S. Pat. No. 6,327,541 is an improved AMR system functioning as an electronic energy management system for use within an energy distribution network that provides energy from an energy resource to user sites. The system comprises a data acquisition subsystem that acquires energy usage data from the energy usage meters. An electronic data storage located at a central location remote from the energy usage meters stores the acquired energy usage data. The internet is used to provide data access to the users.

U.S. Pat. No. 6,178,362 describes an energy and facilities management system and method is provided for energy users with large physical plants. It further describes comprehensive historical analysis of the energy consumption of their physical plant and with the ability to manage it as operations dictate. The process uses the internet and the www to allow real time data retrieval.

U.S. Pat. No. 6,088,688 teaches a massive computerized accounting system for utility resource management methods and systems, multi-user utility resource management methods and systems, and energy-consumption-based tracking methods and systems. This system is a massive historical database with no intelligent analysis.

U.S. Pat. No. 5,962,989 teaches a hardware based method of providing a central control of the operation of the lighting system under minimum and maximum lighting levels, and can provide calibration and set-points for response times to various sensor inputs.

In the area of software agents, U.S. Pat. No. 6,765,900 describes how multiple software agents are implemented in a single computing platform. Each agent is assigned or dedicated to a single virtual private network. Any number of agents can be realized in the computing platform. Each agent runs independently, and is independently configured and managed.

U.S. Pat. No. 6,505,231 provides a plurality of information sources are arranged on a network. An agent program is self-transferred to access the plurality of information sources for executing an information acquiring process.

U.S. Pat. No. 6,496,871 teaches how software agents can be used on distributed networks. A distributed software system and method are provided for use with a plurality of potentially heterogeneous computer machines connected as a network.

U.S. Pat. No. 6,029,175 describes how an intelligent network agent intercepts transactions between clients and servers to perform information processing functions such as automatically retrieving updated files from remote servers and delivering them to local client programs. The invention provides a method to update any number of clients from any number of servers without making any changes to currently existing HTTP clients or HTTPD servers. This system detects the occurrence of changes in the objects of interest, and in response to detecting the occurrence of a change in an object of interest processes prescribed activities or tasks.

Hundreds of patents have been published indicating how a computer network can be used for distributed processing of data in many industries. Thousands of articles on networking have been disseminated and several dozen periodicals are published monthly describing network operations. A typical network system consists of a system in which a server has resident a software application which has been licensed by the operator and this operator allows several clients to utilize the system via online connections over the internet or www. The typical system is described in FIG. 1. Under this operation the operator pays a suite of fees to the several different groups of commercial entities. Some of these fees are listed below:

1. Software License fees—these are paid to the program owner or program lessor.

2. Internet License Fees—these fees are paid to the owner for the right to use the program on the internet such that multiple users can access it online. These fees are substantial being several tens of multiples of the single user fee and vary with the total number of potential users that can use the online system.

3. Internet Service Provider (ISP) Fees—these fees are based on the volume of data exchanged between the users and the ISP servers.

4. Miscellaneous provider fees—these fees are in addition to those mentioned above and are paid to third parties to allow the operator to have duplicate copies of his program application system resident in “mirror” sites to allow rapid transfer of large amounts of data. An example this is the Akamai system described in Ref. 1 in which operators are provided with mirrors of their operations at various sites around the world to enable more rapid transfer of data and website content.

Energy management is a major sub-industry within the overall energy industry complex, in which companies and third parties monitor, record and optimize the use of electricity, gas and other energy producing commodities for commercial and industrial customers. Energy management service vendors are companies like Johnson Controls, Emerson, ASCO, and Power-Measurement. They all provide a vital service to their customers using proprietary systems and charge high prices for their professional services. In the majority of these cases the vendor company has staff at the site of the user and provides real time support for the daily utilization of energy. In many instances these companies have their systems available on the Internet for ease of use, however this availability entails added costs for the customer. Customers are willing to pay the price for these services since energy is usually a major expense item in their annual budgets. This invention described herein is an attempt to lower some of the costs associated with the total energy management problem.

Prior Art Problems:

None of these prior art systems or methods provide for optimization of energy using software agents on the internet, nor do they describe any processes in which expensive software modules are utilized offline on a desktop system by using a software agent “bridge” on a website available on the internet.

The technology used today is burdened with the following problems:

1. Software Expense: Internet based software is expensive to license and expensive to maintain based on the current fees being charged by software vendors. Non-web based costs and license fees on a single machine, usually a single “seat”, are usually in the hundreds or at most thousands of dollars for a single machine whereas web based costs which are expected to service large numbers of machines or “seats” are in the tens of thousands and hundreds of thousands of dollars.

2. The need to maintain a full time web server where the application program is resident, and its attendant equipment and costs at an ISP site or at a separate local site on a 24/7/365 basis.

3. The need for multiple ISPs to service many online customers in the case of a large institution or company.

4. Security: The web server requires a much higher level of web security since it is open to millions of different “hits” by the internet community, whereas a single desktop or local computer cluster is open to few hits and can be adequately safeguarded by appropriate firewall type defenses and safeguards.

5. Ease of use: It is much easier to update and modify a single desktop compared to a host of web servers.

6. Flexibility: The software agent can quickly and efficiently transfer the minimal amount of customer data faster between the primary user and the customers than from a web server and a plurality of customers.

7. Hardware Costs: Today desktop computers are the least expensive component of any network and have the best price/performance value and such can be easily set up to provide economic service in the types of embodiments contemplated herein.

### BACKGROUND OF THE INVENTION

The electric utility industry is a major industry nationally and worldwide. It involves several hundred billion dollars annually in revenues. The major focal point in the system is the management of millions of accounts online and to provide optimal energy management to each customer remotely.

Recently many companies have tried to do this online and have spent millions of dollars to accomplish this objective. One embodiment of the present invention allows the utility to provide services to its customers in an economic and efficient manner.

Typically expensive program licenses are required when a program is used on the Internet where many users can interact remotely. Single user license on a single desktop are comparatively very inexpensive. Typical costs are tens of thousands to hundreds of thousands of dollars for license and maintenance fees annually. An improved means for providing the same services using effective software agents and a single desktop computer or a single computer-cluster can provide the same level or more efficient level of services as a system distributed on the internet.

No cases or processes of energy management been reported wherein the applications program is resident on a desktop; wherein the primary user can interact with remote users on demand or notification, through a set of mobile software agents communicating with these remote users and the primary computer system; where the primary user processes the information and the updated information is sent back to the remote user. By implementing the new processes, which are taught in this application by this invention a system is devised, that allows a single application not resident on the Internet to behave as if it were on the Internet without violating any legal requirements of the owner of the licensed software.

THIS NEW INVENTION provides an improvement in the internet technology whereby the primary user can still utilize the ubiquitous nature of the internet to service several remote users but without the need for multiple copies of the program distributed or the need for a more expensive internet or web license.

Specific Innovations;

1. The primary user can utilize expensive software on a non-internet-based mode to allow Internet based customers to efficiently process data and information.

2. The use of a software agent or other means by the primary user to effect data transfers from the Internet to the desktop, using either a virtual private network (VPN) or non-VPN channels for security purposes.

3. The use of software agents to update energy-management information for online customers via the Internet and world wide web.

4. The application of this combination of desktop—software agent combination to allow expensive software to be economically used by a plurality of users without infringing on the legal licensing arrangements of the software owners.

### SUMMARY OF THE INVENTION

An embodiment of the present invention provides a method and a system for optimizing energy management by a plurality of users on a network without the need for a internet resident applications program by using a software agent and a desktop server. The process consists of a primary user with a computer connected to the Internet and having a software agent set operating from this machine and a plurality of remote customers who interact with the Internet to receive services provided by the primary user. The remote computer users have no ability to interact with the primary computer directly and the optimization program which is resident in his single-user-licensed CPU. An object of this invention is to provide an improved process which uses software agents autonomously, that constantly monitor a remote users' interaction with a website, and on cue or notification, then selectively transfer required data at the appropriate time from the internet website site to a separate computer run by the primary user on which resides the optimizing program module.

### BRIEF DESCRIPTION OF THE DRAWINGS

The present invention can be more readily understood by reference to the accompanying drawings:

FIG. 1 Shows the current industry situation, which has the primary server with programs resident on the internet in a web server and communicating with all the remote users online.

FIG. 2 Shows the present invention wherein a primary server computer with the resident program and software agent is connected to the internet through software agents that collect and transfer the data.

FIG. 3 Login page for client user who logs on to an internet website to prepare data online for energy optimization.

FIG. 4 Client dataset that user remotely prepares online for energy optimization. This data is available on an internet website.

FIG. 5 Completed optimized dataset from primary server. Data is accessed by a software agent which conveys data to primary server CPU in which the optimization program is resident.

### DETAILED DESCRIPTION OF THE INVENTION

The invention comprises of the following computer implemented steps:

Remote users' computers called clients 3 are connected to the internet 2 or to a network, via a public network or via a private network

These clients 3 access websites 25 on the network 2.

These clients 3 update an individualized their dataset 6 which contains their specific data on the website 25.

The desktop 1 or primary server 1 is connected to the internet 2 but not connected directly to these remote clients 3.

The desktop 1 or primary server 1 launches a set of software agents 10 to roam the internet.

These software agents 10 have specific instructions to collect information from client datasets at the prescribed websites 25 and convey this data back to the primary server 1.

The client 3 computer screen shows a flag or icon 19 indicating the status of the computational transaction, being complete, or not.

The primary server 1, usually a high end workstation, has the licensed software optimization application module 8 resident and operational in the system.

The primary server 1, which has sufficient processing power, solves the optimization model for each client dataset either sequentially or simultaneously and prepares the output data.

The primary server launches the software agent set 10 to return the output results 24 to the client websites 25 where the client machines 3 can have access. [Para 71]The client dataset 24 is updated and the transaction flag 19 is changed at the website 25 to complete, indicating that the client data has been optimized.

The primary server 1 archives the energy data and updates a relational database 6 with all the processed energy data.

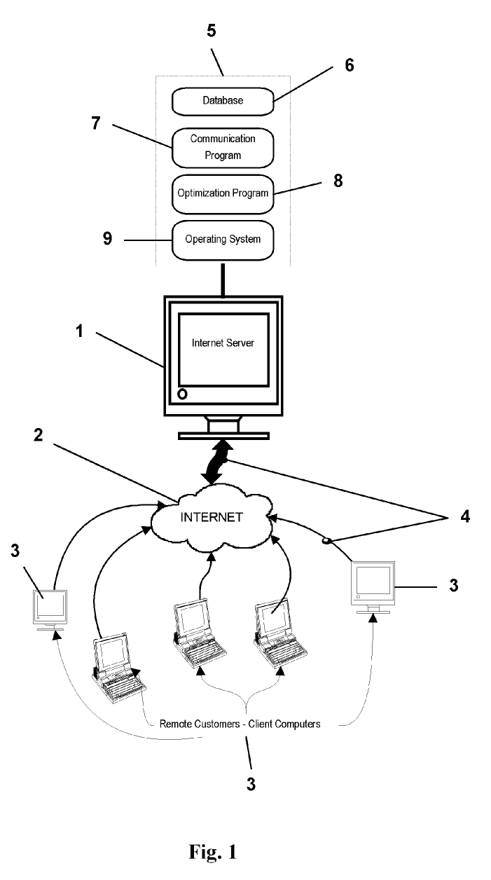

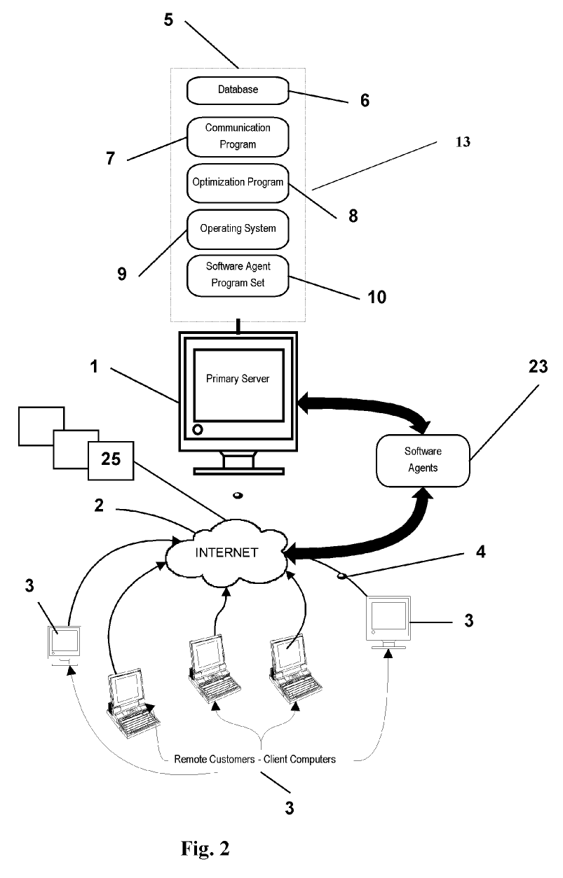

Referring to FIGS. 1 and 2, the primary server 1 is a high-end computer server with sufficient RAM, high-speed CPUs to operate as a single workstation or it can be a Linux type parallel computer cluster in which various parts of the optimization process are segmented and distributed out to several CPUs running in parallel to increase efficiencies. An example is called a “Beowulf Cluster”. This server has communications resources to connect to the Internet 2 and various networks by wired or wireless means. The server has resident in its program structure and memory 5 an operating system 9, a database system 6, a communication program 7, and in this embodiment an optimization program 8 and a mobile software agent set 10. The optimization program 8 is an expensive program licensed to run only on a single computer and not on the Internet 2. It is operated under a desktop license with a single “seat”.

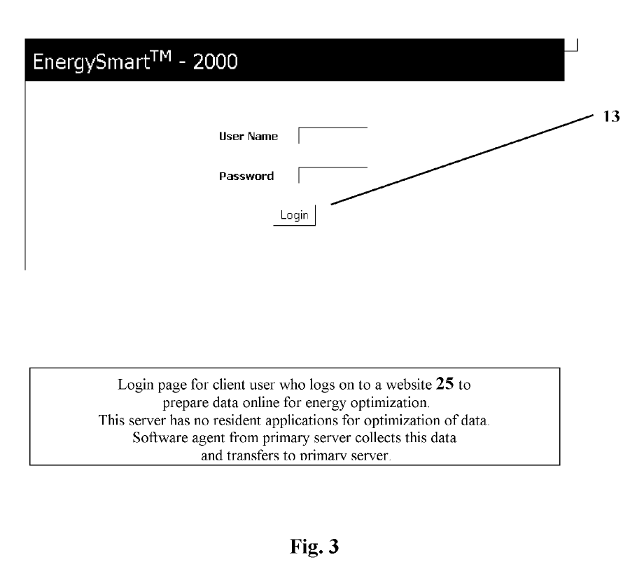

Specifically, in the subject embodiment, the customer using a remote computer or client computer 3 logs onto the public Internet 2 or to a similar network by means of communication links 4 as shown in FIG. 3, to access his website 25. These websites 25 are usually hosted by Internet service providers 22 or ISPs. Using the login frame 13 on the ISP 22 site, the user gains access to the system online to build his dataset 24. In one embodiment shown, the client 3 inputs his energy requirement 14 along with any maximum constraints 15 and minimum constraints 16. The time dependent cost of energy 17 is also input onto the dataset.

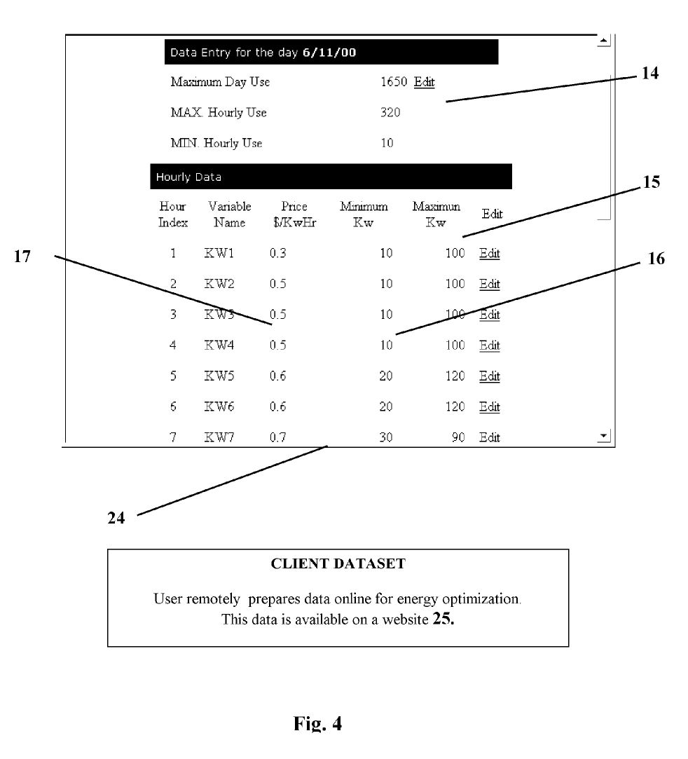

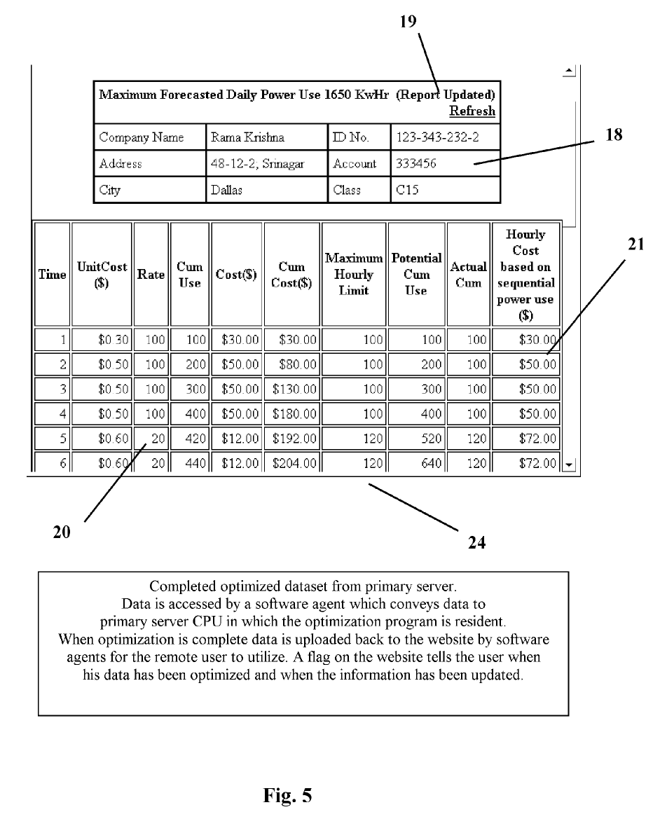

The primary server 1 is running and is connected to the Internet by communication links 4 and using its software agent program 10 launches the software agents 23 to crawl the Internet to locate the plurality of client websites 25. The mobile software agents 23 locate the client websites 25 and collect the dataset information 14, 15, 16, 17, 18, 19 shown in FIG. 4, and returns this information to the primary server 1. Specifically in FIG. 4, item 14 is the maximum energy required during the time period by the user, item 15 is the maximum upper limit of energy that can be used that particular time period, item 16 is the lower limit usable in the time period, item 17 shows the current price of energy in that time period. In FIG. 5, item 18 is the user account number, item 19 is a flag that indicates the status of the computational process. On collecting the user data, the software agent 23 resets the transaction flag 19 in the client system to “incomplete”. The data from the plurality of clients 3 is returned in random order to the primary desktop 1 depending on network traffic on the Internet backbone.

The primary server 1 uses the licensed optimization program 8 to optimize the energy management model and produces the results 20. Item 20 is a vector or list of data that is the result of the energy management process optimization. This data stream represent the optimized values that the user should utilize in his operations to minimize the cost of energy and still meet his constrained requirements. Specifically FIG. 5 shows an image of the completed graphical interface that is visible on the client computer 3 at the end of the optimization process. The details provide hourly use, hourly cost, cumulative costs and a comparison with the situation wherein no optimization was used but the customer utilized energy without any attempt to lower costs. The correct transaction flag 19 shows that the optimized process is complete. The software agent 23 is re-launched to return the completed data shown in FIG. 5, to the original client website 25. The client dataset 24 is updated and displayed on the client computer screen. The software agent 23 resets the transaction code icon 19 to “complete” at the website 25. The primary server 1 archives the dataset information from the client 3 in its relational database 6. The primary server repeats the process to service all the clients that are included in the system.

Having shown above a detailed embodiment of the subject invention, it will occur to those skilled in the art that modifications and alternatives can be practiced within the spirit of the invention. For instance, it will be appreciated that the above procedure is equally applicable to any and all types of programming situations where online customers can effectively and legally use offline expensive, complicated software systems remotely located from their locations, and accordingly the spirit and scope of the subject invention should not be limited to the specific details in the embodiments above.

List of Abbreviations

| Abbreviation | Meaning |
|---|---|
| AMR | Automatic Meter Reader |
| CDMA | Code Division Multiple Access |
| CDPD | Cellular Digital Packet Data |
| CPU | Central Processing Unit |
| FTP | File Transfer protocol |
| GUI | Graphical User Interface |
| ISP | Internet Service Provider |
| KW | Kilowatt |
| OS | Operating System |
| PCS | Personal Communication Services |
| PSTN | Public Switched Network |
| RAM | Random Access Memory |
| TDMA | Time Division Multiple Access |
| TOU | Time of Use |
| VPN | Virtual Private Network |
| WAP | Wireless Application Protocol |
| WWW | World Wide Web |
| x.25 | Modem usage protocol |

### REFERENCES

Ref. 1: www.akamai.com, 8 Cambridge Center, Cambridge, Mass. 02142.
Ref. 2: www.johnsoncontrols.com, Johnson Controls, Inc. Milwaukee, Wis.
Ref. 3: www.emerson-ept.com, Emerson Control Techniques, 12005 Technology Drive, Eden Prairie, Minn. 55344
Ref. 4: www.asco.com, ASCO Power Technologies, 50 Hanover Road, Florham Park, N.J. 07932
Ref. 5: www.pwrm.com, 2195 Keating Cross Rd. SAANICHTON, British Columbia V8M 2A5

What is claimed is:

1. A computer implemented method to utilize expensive licensed computer applications e.g. energy optimization modules, via the internet for a plurality of remote users, without the need for expensive multiple copies of these costly programs on each internet server or the necessity of the energy optimization program modules to be even resident on the internet including the steps of:
utilizing a primary computer system or server connected to a public network;
connecting remote users' computers called clients to the internet or to a network, via a public network or via a private network;
accessing an individualized website containing an individualized client dataset;
updating an individualized client dataset which contains client specific data;
connecting a desktop or primary server to the internet but not to the remote clients;
launching a set of software agents by the desktop or primary server to roam the internet;
providing these software agents with specific instructions to collect information from client datasets at client websites and conveying this data back to the primary server;
providing the client computer screen with a flag or icon indicating that the computational transaction is not yet complete;
providing the primary server, usually a high end workstation, with the licensed software application modules resident and operational in the system;
including in the primary server sufficient processing power to solve the application optimization model for each client either sequentially or simultaneously and to prepare the output data;
re-launching the software agent set from the primary server to return the output results to the client websites;
updating the client dataset and simultaneously changing the transaction flag to “complete” indicating that the client data has been optimized and the process is completed;
archiving the energy data on the primary server and updating a relational database with all the processed energy data.

2. Method in which the primary computer system of claim 1:
comprises: at least one processor, RAM;
and licensed computer software embodied in a storage medium, comprising:
multi-layered architecture software with an operating system and a set of software agents, communication programs, database programs, licensed optimization applications programs capable of using linear methods or using nonlinear methods for formulating optimization parameters, formulating outputs, where outputs are tabular or graphical and where outputs are made available in real time.

3. Method in which the primary computer system of claim 1 is connected to internet.

4. Method in which the client computer system of claim 1 is connected to internet.

5. Method in which the primary computer system of claim 1 makes data available in real time or substantially in real time.

6. The primary computer system of claim 1, further comprising a graphical user interface GUI that uses standard application system application programming interfaces which allow interaction across the internet or intranets.

7. The primary computer system of claim 1, wherein said system is adapted to administer a plurality of dissimilar legacy systems and dissimilar client requirements, business functionality logic, and regulatory requirements.

8. The primary computer system of claim 1, wherein said at least one communication server supports at least one of CDMA, telephone & international standards, PSTN, PCS, WAP, x.25 modem, RAM, CDPD, and TDMA environments.

9. The primary computer system of claim 1, wherein said at least one program task is responsible for failover processes, said failover processes being operations to be performed in the case of failure, said failure being determined based on conditions returned after executing an activity.

10. Method shown in claim 2 above where the output information is made available on the internet for user interaction comprising:
generating of graphics data;
generating of tabular data;
uploading data and graphics to central internet site;
making output data available to user by any or all of the following means, email, fax, ftp, telephone, radio frequency.

11. Method in claim 1 for allowing mobile software agents to function on a set of computer systems, each system having a set of resources allowing each agent to move from an environment on one system to an environment on another system.

12. The system of claim 2 where a subset of the set of agents may perform network management functions.

13. The system of claim 2 where a subset of the set of agents may act as a user application.

14. The system of claim 2 where each agent in a subset of the set of agents may access a resource on a system other than which the agent is currently executing.

15. The method of claim 2, wherein said agent can send dataset information by any of several communicative means comprising; ftp, email, chat, telephone.

16. An energy management model and process comprising:
means for providing input data to a desktop server;
means coupled to said means for providing access to energy management application programs resident on said server and isolated from remote users;
means for utilizing applications program offline;
means for updating the remote users with energy management information developed by the primary server.
